(19) United States
(12) Patent Application Publication
(10) Pub. No.: US 2009/0279764 A1
(43) Pub. Date: Nov. 12, 2009

(54) SMALL-SCALE DIAGNOSIS SYSTEM

(75) Inventors: Daisuke Kaji, Tokyo (JP); Mamoru Umeki, Tokyo (JP); Hisashi Yonekawa, Tokyo (JP); Jiro Okuzawa, Tokyo (JP); Wataru Motoki, Tokyo (JP); Takao Shiibashi, Tokyo (JP); Shintaro Muraoka, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: KONICA MINOLTA MEDICAL & GRAPHIC, INC., Tokyo (JP)

(21) Appl. No.: 12/091,157

(22) PCT Filed: Oct. 25, 2006
(86) PCT No.: PCT/JP2006/321212

§ 371 Date: Apr. 22, 2008

(30) Foreign Application Priority Data
Oct. 27, 2005 (JP) 2005-312713
Oct. 28, 2005 (JP) 2005-314567
Apr. 3, 2006 (JP) 2006-101985

(51) Int. Cl. G06T 7/00

(52) U.S. Cl. 382/132

(57) ABSTRACT

The present invention is to provide a small-scale diagnosis system for conducting simple and efficient examination, including: an image creating apparatus for creating photographic image data of examination object; a CPU to conduct image processing for creating defined photographic image data from the photographic image data; an input section to input the examination object information to specify the photographed examination object; a CPU to correlate the defined image data created and examination object information corresponding to the defined photographic image data; a server to store the defined photographic image data having been correlated and the examination object information; a display section capable of displaying at least any one of the photographic image data, the defined photographic image data or the examination object information; and a control device having at least the CPU to carry out image processing, the CPU to carry out correlation processing and the display section.

### FIELD OF THE INVENTION

The present invention relates to a small-scale diagnosis system, and in particular, to a small-scale diagnosis system used in small-scale medical facility.

### PRIOR ART

There has been know an diagnosis system where using image creating forming apparatuses such as a CR (Computed Radiography) device or FPD (Flat Panel Detector), a technician photographs a patient who is a object of examination and carries out image processing such as tone processing to make the obtained image suitable for examination, then outputs the image having been processed by image processing on a film to be made available for a doctor to carry out interpretation of radiogram.

With such diagnosis system, a plurality of persons shear roles to carry out examination, namely a person (receptionist) to receive a patient visited a hospital, a person (technician) to actually photograph the patient in a photographing room and creates a digital image, a person (a technician who is assigned among ordinary technicians) to judge whether or not tone of the obtained image is suitable for examination and correct contrast and density as needed in some cases and a person in charge of interpretation of radiogram to judge (diagnoses) presence of illness based on the image.

In the past, the image of the patient has been hard copied onto a film so as to be provided for examination (interpretation of radiogram). In recent years, as seeing in a PACS system, the image is displayed at an workstation (on a viewer) exclusive for interpretation of radiogram located remote place from a console. For example, in examination of breast images, a film less system, where the image is displayed at a higher resolution workstation (viewer) than a workstation (PC: Personal computer) having an ordinary display resolution, has been introduced (for example, Patent document: U.S. Pat. No. 5,235,510 specification).

In a large-scale medical facilities to which the conventional diagnosis system is assumed to be applied (hereinafter called large-scale facility), a plurality of image forming apparatus and technicians to operated the apparatuses thereof are available and the consoles to operate the image forming apparatuses and viewers for doctors to observe the image data are provided respectively to share the roles. Therefore, there is a risk that patients and image data are mismatched.

To prevent the mismatch, there is suggested a system where each apparatus is incorporated through a network and in a stage of reception, an instruction information so called photographing order information including information of the patient (name and age of the patient) and information of photographing (data of photographing and region of photographing) is created so that the photographing order information and the image data are matched through the network.

Namely, in the system used in such a large-scale facility, a place in charge of each role is often located remote place in a large hospital, i.e. the reception on a first floor and a department of radiology on a basement (B1) etc, and in the department of radiology, it is common that a plurality of doctors carry out photographing of a plurality of patients simultaneously using a plurality of photographic apparatus. Also, it is assumed that the plurality of patients stay within each process. Therefore, it is conducted that the photographing order information is issued at the stage of reception in advance, and ID appended for each work at each process are matched with the photographing order information through the network such as HIS (Hospital Information System) or RIS (Radiology Information System) (refer to Unexamined Japanese Patent Application Publication Nos. 2002-159476 and 2002-311524.

For example, at the reception on a first floor, items of examination (items of photographing) are determined in accordance with an appeal of the patient, and the patient information and photographing information along with examination ID is registered. Thereby, such photographing order information as in FIG. 14(a) is created. The above photographing order information is continually added and displayed on the workstation (hereinafter called WS) at the reception on the first floor. At the same time, the aforesaid photographing order information is displayed on a console in the department of radiography on a basement via the network such as RIS and HIS (hereat, “console” means a workstation located in the department of radiography to display setting of photographing conditions, the photographing order information of RIS and HIS or the photographic of the patient). Meanwhile a plurality of consoles are usually provided to enhance an efficiency of decentralized processing, and these consoles are also interconnected through the network. When a specific examination ID is selected on any console, to prevent duplication of photographing among the plurality of the doctors, a method that a patient list notifies that the ID is in a process by flashing, changing color or beep when the same ID is assigned is employed.

A doctor of the department of radiology uses the a console nearby to select the examination ID to be photographed from the displayed photographing order information and to register an ID (cassette ID) of CR plate to be used. Thereby, as FIG. 14(b) shows, the registered cassette ID is displayed on a column of “cassette ID” of the photographing order information. The doctor, for example, carries three cassettes and moves to a photographing room to photograph the patient. Afterward, the photographed cassettes are read by a reading device to create image data. When this occurs, the reading device reads the cassette ID applied on the cassette being inserted and appends the cassette ID to the image data created. The image data to which the cassette ID is append is transmitted to a console where the doctor selected the examination ID and the examination ID (patient ID) and the image data are associated based on the cassette ID. As above, by associating the photographed order information and the image data, it becomes possible to prevent mismatching of the patient and the image data even in the large-scale facilities.

Then the image data transmitted to the console is displayed on a display section of the console. At this stage, positioning of photographing is examined. In case of positioning failure, photographing is carried out again, and also whether correction of density and contrast or frequency enhancement treatment are applied or not is judged. Thereafter, the image data is stored in an interpretation waiting sever in which image data waiting for interpretation of radiogram (diagnosis) is stored. A doctor to conduct interpretation of radiogram extracts the image data related the patient from the image data stored in the interpretation waiting server to display it on the workstation (a high resolution monitor is often provided for viewing function) in an interpretation of radiogram room to carry out interpretation of radiogram (diagnosis).

[Patent document No. 1]
U.S. Pat. No. 5,235,510
[Patent document No. 2]

### Unexamined Japanese Patent Application Publication No. 2002-159476

[Patent document No. 3]

### Unexamined Japanese Patent Application Publication No. 2002-311524

### DISCLOSURE OF THE INVENTION

### Problems to be Solved by the Invention

However, according to a survey by inventors of the present invention, in case of relatively small-scale medical facilities (hereinafter small-scale facilities) such as a doctor in private practice or a clinic, the number of the image forming apparatuses is small, and in many cases an assistant conducts positioning of the patient and the doctor controls X-ray radiation switch when completion of positioning is notified from the assistant, or whole operation including positioning of the patient is conducted by the doctor.

Also, for example, in case of large-scale facilities, it is assumed that the patient has to go up and down across a plurality of floors in the facility from photographing to examination by a doctor, however, incase of the small-scale facilities, because of small facility, a moving distance of the patient from photographing to examination of the doctor is short.

Under the circumstances, in the small-scale facilities, it is cannot be presumed that the image data is mismatched with the patient. Therefore if the same system used in the large-scale facility is employed in the small-scale facility, register work to issue the photographing order information at the reception and matching work to match the photographing order information with the cassette ID become necessary, thus the procedure becomes complicated and efficiency of medical examination is deteriorated by contrast. In the small-scale facility, since a doctor seldom examines a plurality of patients simultaneously, the above mentioned register work and matching work become a large load for the doctor and the efficiency of examination is deteriorated though there is a demand to improve the efficiency by immediately providing the photographic data to the examination.

Also, to create the photographing order information in advance and to correlate the photographing order information with the photographic data, a system to connect each device to a network applicable for a main system such as HIS and RIS becomes necessary. However, there is a problem that configuring such system is costly and it will be a burden for small-scale facilities.

Also, it is considered that the aforesaid matching is realized by coordinating a receipt computer (Rececom™) and electronic chart, however, it is difficult to operate integrally since specification of each device maker is different. Further, it is not suitable for small-scale facilities just by reducing the number of devices leaving a configuration concept of the aforesaid large-scale facility as it is.

Furthermore, image processing has to be conducted for photographic image data with most suitable image processing condition for the photographed region. In large-scale facilities, it is predicted that various symptoms of patients are examined, thus the most suitable image processing conditions to cope with several hundred of photographing regions are prepared. Therefore, at a time of register of photographing order before photographing or at a time of image processing after photographing, by selectively displaying photographing regions on a monitor form several hundred of photographing regions prepared, the doctor can select the most suitable photographing region for the image data from the photographing regions displayed.

However, since a patient having a serious symptom is introduced to large-scale facilities, in small-scale facilities, the symptoms to be examined by their own are limited, thus the photographing regions are typical regions. Under the circumstance, the system where the doctor selects a suitable photographing region for the image data from several hundred of photographing regions is complicated and not appropriate for a working style of the doctor.

The present invention is achieved to solve the above problems and an object of the present invention is to provide a small-scale diagnosis system where examination can be conducted simply and efficiently by simple operation without the doctor being troubled unnecessarily.

### Means for Solving the Problems

The above object is attained by the following structures.

To resolve the above problem, the small-scale diagnosis system of the present invention photographs a patient representing an examination object and creates image data, thereafter displays and provides the image data on a viewer for examination, correlates the image data displayed on the viewer with the patient, and stores the associated image data and information about the patient. The small-scale diagnosis system, includes: an image creating apparatus for creating photographic data of the examination object based on the image data obtained by photographing the patient; an image processing device for creating defined photographic image data from the photographic image data created by the image creating apparatus; a first input device for inputting examination object information to identify the examination object; a correlation device for associating the defined photographic image data created by the image processing device and the examination object information corresponding to the defined photographic image data; a storing device to the defined photographic image data having been associated by the correlation device and the examination object information; and a display device capable of displaying at least one of the photographic image data, the defined photographic image data or the examination object information; wherein a control device is provided with at least the image processing device, the correlation device and the display device.

According to the small-scale diagnosis system, creation of defined photographic image data, displaying of the photographic image data or the defined photographic image data, and association of the examination object information with the defined photographic image data can be conducted by one control device and the examination object information and the defined photographic image data stored in a storing device in a correlated state.

### EFFECT OF THE INVENTION

According to the invention described in claim 1, operations such as creation of a defined photographic image data, matching of the defined photographic image data with examination object information and displaying photographic image data had been conducted in individual device such as the console and the viewer can be conducted in one control device. Therefore, in a circumstance of a relatively small-scale facility such as private medical practice where staff and facility are few, there can be an effect that the burden of the doctor can be relieved, since the plurality of devices are not necessary to be operated.

That is, in a circumstance where the number of doctors and assistants to operate various kinds of devices are few, or one doctor conducts from photographing to medical examination in some occasion, there is less possibility of mismatching the patient and the photographic data. Thus in the invention described in claim 1, for example, a control device such as a workstation (PC) where a console to operate image forming apparatus and a viewer to display the photographic data for observation are combined is provided in a room where the doctor to conducts medical examination is installed. After photographing the patient, the image data is immediately displayed on the control device and image processing such as tone processing is carried out if needed, thereafter the doctor conducts medical examination based on the photographic data. Thereby duplicated input operation through key board by the doctor, a nurse or the assistant, and setting and operation of the plurality of the devices are not necessary. Thus the doctor can concentrate medical examination.

Also, since correlating of the defined photographic data representing a final image for examination with the patient can be conducted by the same control device, photographic data can be sorted out readily without operating special devices or inputting photographic image order information. Thus the burden of the doctor can be relieved. Further, as above, after correlating the photographic data with information related to the examination object such as a name of the patient, the photographic data is stored in a storing device such as a server, therefore, the photographic image data can be effectively utilized as a comparison image to examine progress of curing for next examination.

Furthermore, since the photographic image data is displayed on the display device for examination, a film is not used to store the photographic image data and examination data. Therefore a cost is saved.

According to the invention described in claim 2, with a plurality of the image forming apparatuses, photographing of a plurality of the patients can be conducted simultaneously. Also, in case photographing is conducted using the plurality of image forming apparatuses, the created photographic data is transmitted to one control device such as the workstation (PC) installed, for example, in a room where the doctor conducts examination, and processed. Thus operator such as the doctor can sort the photographic data readily without operating special devices or a keyboard for input. Thus, in the small-scale facility where staff such as doctor is few, there is provided an effect to improve a working environment by relieve the burden of the doctor so that the doctor can concentrate on medical examination.

According to the invention described in claim 3, since photographing can be conducted through a plurality of kinds of image forming apparatus such as radiographic imager, ultrasonograph and endoscope imager, an appropriate apparatus for each patient can be used for photographing in accordance with requirement. In this case, the created photographic image data is transmitted to one control device such as the workstation (PC) installed, for example, in the room where the doctor conducts examinations and processed. Thus operator such as the doctor can sort the photographic image data readily without operating special devices or a keyboard for input. Thus, in the small-scale facility where staff such as doctor is few, there is provided an effect to improve a working environment by relieve the burden of the doctor so that the doctor can concentrate on medical examination.

According to the invention described in claim 4, density or contrast of the photographic image data can be corrected through the control device such as the workstation (PC) installed, for example, in the room where the doctor conducts examination, and processed. Thus the operator such as the doctor can readily correct photographic data without moving across a plurality of apparatuses. Thus, in the small-scale facility where staff such as doctor is few, there is provided an effect to improve a working environment by relieve the burden of the doctor so that the doctor can concentrate on medical examination.

According to the invention described in claim 5, an examination object information can be appended to the photographic data by an information appending device equipped on the image forming apparatus. Therefore, correlating of the image data and the patient who is an object of photographing becomes possible, which realizes an effect that mismatching at later medical examination is prevented.

According to the invention described in claim 6, since an conversion device to convert an analogue signal to a digital signal is provided, in case the image forming apparatus outputs an image data which does not conform with a standard of existing apparatuses installed in each facility to which the present system will be applied, the image data is appropriately converted to be applicable. Therefore, existing apparatuses can be used as they are and there is provided an effect that an additional investment for facilities is not necessary.

According to the invention described in claim 7, since the examination object information can be append to the photographic image data by the conversion device, the image and the patient who is the object of photographing can be correlated readily and an effect that a risk of occurrence of mismatching at later examination can be prevented is provided.

According to the invention described in claim 8, 12 and 13 it becomes possible that the processed image data, to which optimum image processing is applied in accordance with the photographing region, can be provided immediately for interpretation of radiogram.

According to the invention described in claim 9, by his/her own choice, the doctor can correct image quality of the processed image data having been automatically processed.

According to the invention described in claim 10, the processed image data or corrected image data can be managed using the information of patient.

According to the invention described in claim 11, since the result of the correction can be reflected to the predetermined image processing conditions, optimization of image processing suited to the doctor can be realized.

According to the invention described in claim 14, a broad photographing region can be assigned through simple operation where the photographing region can be selected from human body region icon displayed on the display section when image is read in the readout device.

According to the invention described in claim 15, the image processing according to the photographing region can be carried out efficiently by an external apparatus when the image processing is carried out for the photographic data read in the readout device.

According to the invention described in claim 16, a detailed photographing region can be automatically recognized based on the broad photographing region selected by the human body region icon. Therefore, it is not necessary to carry out region recognition processing to recognize the photographing region from scratch and the efficiency of processing and medical examination in a small-scale facility can be enhanced. Also, when the detailed photographing region is automatically recognized, the photographing region can be narrowed down to a certain range in which the photographing region is included by selecting the broad photographing region. Therefore, recognizing mistakes in automatic recognizing becomes fewer and recognizing accuracy can be improved.

According to the invention described in claim 17, only by touching one icon representing a region in human body region icon, a broad photographing region can be readily selected.

### BRIEF DESCRIPTION OF THE DRAWINGS

FIG. 1 is a block diagram showing a system configuration of a small-scale medical diagnosis system related to the present invention.

FIG. 2 is a drawing showing an exemplary lay-out of each apparatuses in a medical facility in case the small-scale medical diagnosis system shown in FIG. 1 is utilized.

FIG. 3 is a block diagram of main sections showing a schematic configuration of a control device.

FIG. 4 is a view showing an exemplary patient list confirmation screen.

FIG. 5 is a view showing an exemplary image confirmation screen.

FIG. 6 is a view showing an exemplary processing condition table.

FIG. 7 is a view showing an exemplary tone conversion table.

FIG. 8 is a flow chart describing a flow of image processing in an image processing section.

FIG. 9 is a flow chart showing an operation of a small-scale medical diagnosis system in a first embodiment.

FIG. 10(a) is a view showing an exemplary column of a patient name and a reception number in an image confirmation screen shown in FIG. 5.

FIG. 10(b) is a view showing an exemplary column of a patient name and a reception number in an image confirmation screen shown in FIG. 5.

FIG. 11 is a block diagram of main sections showing a schematic configuration of a readout device.

FIG. 12 is a flow chart showing operation of a small-scale medical diagnosis system in a second embodiment.

FIG. 13 is a diagram showing an exemplary human body region icon shown on a display section.

FIG. 14 is a view showing an exemplary registration screen of photographing order information in a conventional large-scale medical diagnosis system.

### DESCRIPTION OF SYMBOLS

1 Small-scale diagnosis system
2 Image creation apparatus
2a Ultrasonograph
2b Endoscope imager
2c Radiographic imager
3 Control device
4 Server
6 Network
11a Reception device
21 Conversion device
22 Photographing device
23 Readout device
31 CPU
32 RAM
33 Memory section
34 Input section
35 Display section
35a Patient list confirmation screen
35b Image confirmation screen
36 Communication section
38 Image processing section
331 Processing condition table

### PREFERRED EMBODIMENT OF THE INVENTION

A preferred embodiment of the invention will be described with reference to the following drawings without a technical scope of the present invention being restricted by description in the specification.

### First Embodiment

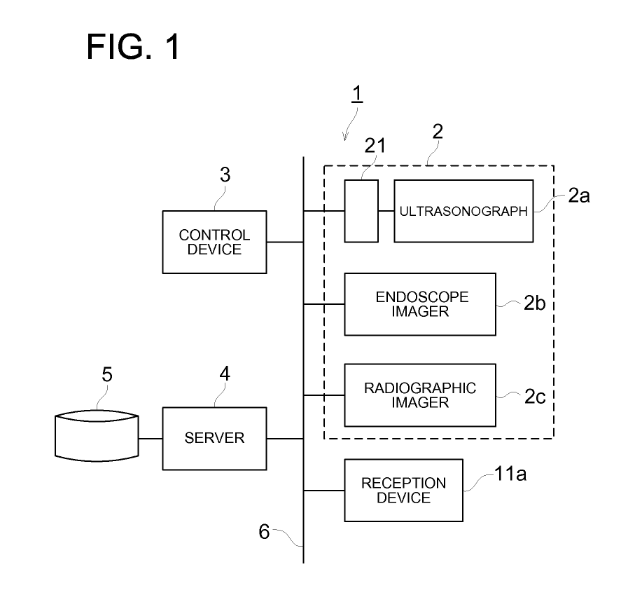

First, a first embodiment of a small-scale medical diagnosis system related to the present invention will be described with reference to the FIG. 1 to FIG. 10.

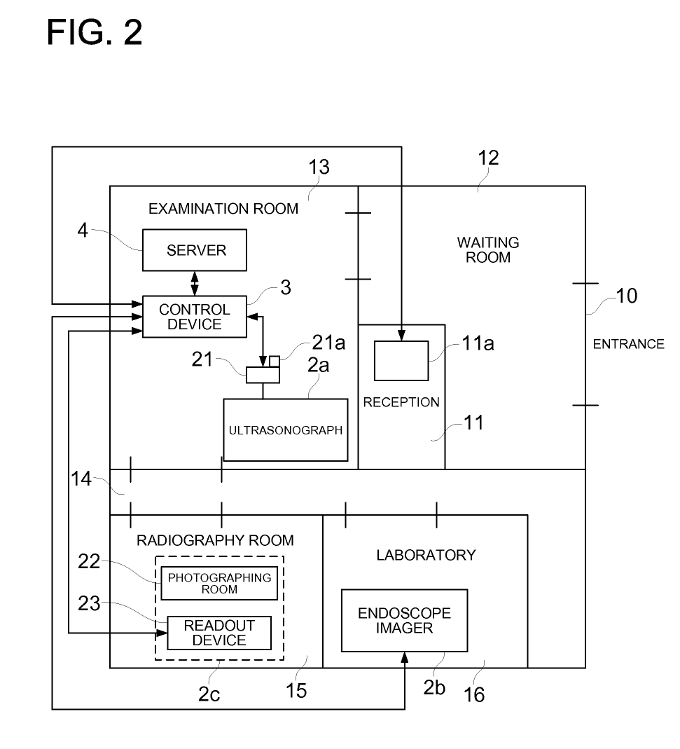

FIG. 1 is shows a system configuration of a small-scale medical diagnosis system 1 related to the present embodiment, and FIG. 2 shows an exemplary lay-out of each apparatus in a medical facility in case the small-scale medical diagnosis system 1 is utilized.

The small-scale medical diagnosis system is a system to carry out a successive operation from reception of a patient, to medical examination of a doctor and payment, which is applied to relatively small-scale medical facilities such as a medical practice or a clinic. As FIG. 1 shows, the small-scale medical diagnosis system 1 is configured with an ultrasonograph 2a, endoscope imager 2b and radiographic imager 2c which represent image creating apparatus 2, a control device 3, a server 4 and a reception device 11a, and each of the apparatuses and devices is connected to a communication network (hereinafter called network) such as a LAN (Local Area Network) via, for example, an unillustrated switching hub. Meanwhile, the number of each device is not limited in the small-scale medical diagnosis system 1 however, it is preferred that only one control device 3 is provided in the small-scale medical diagnosis system from a view point of saving of operator's movement by centralizing control of entire system in one place.

As a communication method in a hospital, generally, DICOM (Digital Image and Communication in Medicine) standard is used, and for communication among each device which is connected to LAN, DICOM MWM (Modality Worklist Management) or DICOM MPPS (Modality Performed Procedure Step) is used. Meanwhile, the communication methods applicable to the present embodiment are not limited by the methods thereof.

For example, in the small-scale medical facilities such as medical practices or clinics, each apparatuses are allocated as FIG. 2 shows.

That is, a patient enters to an entrance 10, and finds a reception 11 where a reception device 11a to receipt the patient is provided and a waiting room 12. At the reception 11, a reception device 11a is provided. A reception number is given to the patient when reception is processed by the patient at the reception device 11a. At this stage, a reception number ticket (reception ticket or consultation ticket) where the reception number is printed may be given.

When reception is processed, the reception device 11a forms a patient list where the patients are listed in a reception order.

Meanwhile, a receptionist may be assigned at the reception 11 for hearing and inputting the name of the patient via the reception device 11a. In this case, it is preferable that the receptionist also conducts input work of necessary matters related to receipt based on a medical record of latest examination of the patient and the reception device 11a performs a function of a receipt computer (hereinafter called Rececom™)

Next to the waiting room 12, an examination room 13 where the doctor conducts examination and diagnosis of the patient is provided with a door for separating. For example, on a desk (unillustrated) for examination in the examination room 13, a control device 3 through which the doctor can input information of the patient (examination object information) or can display a photographed image on the viewer to observe, and a server 4 representing a storing device where various kinds of information such as photographic data can be stored are provided. Also, in the examination room 13, there is provided an ultrasonograph 2a, which is not necessary to be used in an isolated space in a view point of privacy.

Also, on the other side of a corridor, opposite to an examination room, a radiography room 15 where radiography is conducted is provided. In the radiography room 15, a radiographic imager 2c configured with a photographic device 22 and readout device 23 is provided. Further, next to the radiography room 15, a laboratory 16 is provided. In the laboratory 16, an endoscope imager 2b is provided.

As above, in the present embodiment, on the same floor, the waiting room 12 where the reception 11 is provided, the medical examination room 13, the radiography room 15 and a laboratory 16 are located. The patient to be diagnosed, photographed or examined is registered at the reception, and moves to the medical examination room 13, then after being interviewed by the doctor, moves to the photographing room 15 or the laboratory 16 to be photographed or examined in accordance with an instruction of the doctor. The patient returns to the medical examination room again after photographing or examination is completed, and is examined or diagnosed by the doctor based on a created photographic data. Therefore, the successive movements can be completed by moving relatively short distance in each room and the corridor 14. Meanwhile, the lay-out of each room and each apparatus are not limited to the examples show by FIG. 2.

The ultrasonograph 2a is configured with an ultrasonic probe to output ultrasonic and an electronic apparatus connected with the ultrasonic probe to convert a sonic wave (echo signal) received by the ultrasonic prove into a photographic data of an internal structure (all unillustrated). The ultrasonograph 2a transmits ultrasonic into inside of the body form the ultrasonic prove, reflected sonic wave (echo signal) by the inner structure is received by the ultrasonic probe again, and the electronic apparatus create photographic data based on the echo signal.

To the ultrasonograph 2a, a converter to convert an analogue signal to a digital signal is connected, and the ultrasonograph 2a is connected to the network 6 via converting device 21. As above, via converting device 21, even in case the ultrasonograph 2a outputs data in a form which does not conform with a standard (for, example, communication protocol) of external equipment connected to the network 6, data can be transmitted and received between the external equipment connected to the network by appropriate converting.

In the conversion device 21 representing conversion means, for example, an input operation section 21a configured with ten key board, key board, touch panel and card reader are provided. The input operation section 21a functions as an information appending device to append the retrieval ID to the photographic data by inputting the retrieval ID as the examination object information to identify the patient who is an object of examination.

Here, “examination object information” means information which identifies a patient who is an object of examination, which includes “retrieval ID” representing a serial number (reception number) described on a patient registration card held by the patient, “patient information” representing private information of the patient such as name of the patient and photograph type information representing information to specify type of photographing such as a simple photographing without using developing agent or photographing using developing agent.

Meanwhile, the Retrieval ID is identification data to identify the patient who is an object of the photographing when the photographed data is retrieved after photographing, and in this case, it is the reception number given when reception is processed. In the small-scale medical diagnosis system 1 of the present embodiment, photographing of the patient is carried out first without creating and issuing photographing order information for the patient in advance, and after creating photographic data in a digital form, the doctor correlates the patient information and the photographic data. When correlating, the retrieval ID is used for retrieval of image data.

In case the reception number is inputted as the retrieval ID through the input operation section 21a, for example, when a patient to whom a reception number “001” is given at the reception 11, is photographed, “001” is inputted through the input operation section 21a as a retrieval ID corresponding to the patient. In medical practices, usually, the number of patients visiting the practice is about 10 to 40 thus two digits of the serial number on the patient registration card is more than sufficient. The input operation section 21a has only to input numerals having two digits, thus an economical ten key is preferred.

Also, through the input operation section 21a, besides such retrieval ID to identify the object of examination (patient), photographing type information may be inputted as examination object information. The information inputted is append to the photographic data as appendix information of header information, and when the photographic data is transmitted to external equipment, the information is also correlated to the photographic image data and transmitted.

Meanwhile, a case where the reception number is used as the retrieval ID will be described as an example as follows, without the retrieval ID being limited to the reception number.

The endoscope imager 2b is configured with a small photographic device mounted on an end section of a flexible tube (neither unillustrated). The photographic device is provided with, an objective optical system configured with, for example, optical lens, an imaging section disposed at an image position of the objective optical system and a lighting section configured with LED (Light Emitting Diode) to illuminate as photographing requires (neither unillustrated). The photographing section is provide with, for example, a solid imaging element such as CCD (Charge Coupled Device) and CMOS (Complementary Meta-Oxide Semiconductor) to carry out photoelectric conversion so that an incident light is converted into an electric signal in accordance with an amount of the incident light when the light enters. The objective optical system is configured so that the optical lens converges the light of an area where the lighting section illuminates and forms an image on the solid imaging element which the imaging section has. By converting the incident light into an electric signal, photographic data is outputted as the electric signal.

The radiographic imager 2c is so called CR (Computed Radiography) configured with an imaging apparatus 22 and readout device 23. The imaging apparatus 22 having an unillustrated radiation source radiates a radiation ray onto the object of examination to photograph a still image. When photographing, a radiation ray image conversion medium, in which a radiation ray image conversion plate having a photostimulable phosphor sheet to accumulate energy of the radiation ray is incorporated, is placed within an irradiated area by the radiation ray. An amount of radiation ray based on distribution of transmittance of the radiation ray of the object of examination in respect to an amount of radiation ray radiated from the radiation source, is accumulated in a photostimulable phosphor layer of the photostimulable phosphor sheet incorporated in the radiation ray image conversion medium thus the radiation ray image information of the object of examination is recorded in the photostimulable phosphor layer.

The readout device 23 is an apparatus to read the radiation ray image information of the object of examination from the radiation ray image conversion medium and to create the photographic data by loading the radiation ray image conversion medium in which the radiation ray image information of the object of examination is recorded. Based on a control signal from the control device 3, the readout device 23 radiates an excitation light onto the photostimulable phosphor sheet of the radiation ray image conversion medium loaded inside. Thereby a photostimulable light emitted from the sheet is converted into an electric signal, and the obtained image signal is converted into digital signal by A/D conversion to create a photographic data.

Meanwhile, the radiographic imager 2c can be an integrated apparatus where the photographic device 22 and readout device 23 are combined. Also, FPD (Flat Panel Detector) which directly create an image signal in accordance with the amount of the radiation ray of the object of examination can be applied as the radiation ray image conversion medium. The FPD where photoelectric conversion elements are allocated in a matrix shape can directly create photographic data without the readout device 23 being required.

Meanwhile, for the readout device 23 of the endoscope imager 2b and the radiographic imager 2c, for example, the ten keyboard input device is provided as a photographic appending device incorporated or connected externally which appends the examination object information such as the retrieval ID to the image data at photographing in the same manner as the input operation section 21a of the conversion apparatus 21 in the ultrasonorgraph 2a. Thus the examination object information of the patient is appended to the created photographic data.

Next, the server 4 is a computer configured with a CPU (Central Processing Unit), a RAM (Random Access Memory), a memory section, an input section, a display section and a communication section (all unillustrated). The server 4 is equipped with a database 5 (see FIG. 1) to configure a storing device to store the photographic data transmitted from the control device 3 via the communication section.

The control section 3 locating in, for example, the examination room 13 functions as a workstation (PC: Personal computer) for the doctor to display photographic data for interpretation of radiogram and examination. Also, in accordance with an instruction of the doctor, image creation conditions related to digitalizing of the photographic data in the photographing apparatus 2 or image processing conditions of the photographic data is controlled. Meanwhile, the control device 3 can be provided with a monitor (display section) having higher resolution than that of general PC.

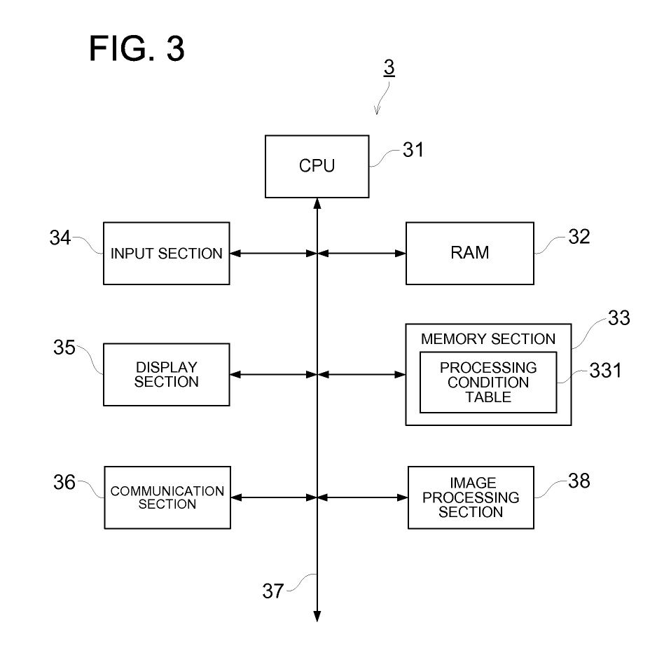

FIG. 3 is a block diagram of main portions showing a schematic configuration of the control device 3.

As FIG. 3 shows, the control device 3 is configured with a CPU 31, a RAM 32, a memory section 33, an input section 34, a display section 35, a communication section 36 and an image processing section 38, wherein each section is connected to a bus 37.

CPU 31 reads out various programs such as a processing program and a system program stored in the memory section 33 and loads in the RAM 32, and carries out various processing, for example, region confirmation processing where the photographed region is automatically recognized by carrying out image analysis, image processing such as tone conversion processing and frequency enhancement processing and correlating processing to correlate defined image data and examination object information in accordance with the program loaded.

The memory section 33 is configured with a HDD (Hard Disc Drive) and a nonvolatile memory of semiconductor. In the memory section 33, various programs are stored as mentioned above. Besides, a region identification parameter (a lookup table to correlate a contour and shape of the object of photographing appeared in the photographic image with the photographing region) to identify the photographed region disclosed in Unexamined Japanese Patent Application Publication Nos. H11-85950 and 2001-76141 and a process condition table 331 (a lookup table which defines a tonal curve used in tone processing and a degree of enhancement in frequency processing) are stored.

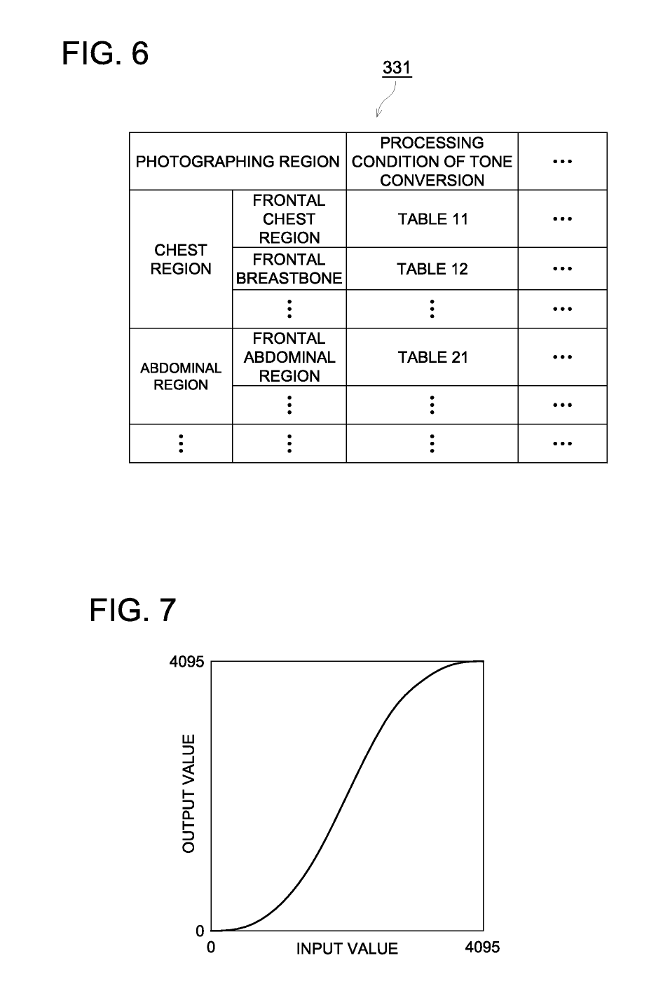

In the processing condition table 331, as FIG. 6 shows, basic processing conditions of various image processing such as tone conversion processing carried out in the image processing section 38 for each photographed region is stored. Here, the photographing regions are categorized not only by the regions of photographed object but by figures of photographing (for example, direction of photographing such as front view and diagonal view, and photographing conditions such as an upright position and a lie position). The image processing conditions memorized in the processing condition table 331 are prepared in accordance with the photographing region in advance and are applied when the photographing image data in the image processing section 38 is automatically processed by image processing.

For example, when tone conversion processing is carried out, a tone conversion table (lookup table) where a relationship between an input pixel value and an output pixel value are determined shown by FIG. 7, is used. As FIG. 7 shows, the relationship between the input pixel value and the output pixel value is described by a characteristic curve in a shaped of S. By changing an inclination of the characteristic curve, rotating the curve or shifting the curve in parallel, density and density characteristic of contrast of an image (output image) at time of outputting the photographing image can be adjusted. An optimum density characteristic in the output image differs with each photographed region. Optimum tone conversion tables for each photographing region such as a chest region front, a breastbone front, an abdominal region front and an abdominal region side are prepared and stored in the memory section 33. In an example shown by FIG. 6, a tone conversion table “table 11” are stored as the image processing conditions of tone conversion processing to be applicable to the photographing region of chest region front.

Also, not only the above mentioned tone conversion processing, the image processing conditions such as an enhancement coefficient in the frequency enhancement processing when sharpness is adjusted, a correction frequency band in dynamic range compression processing which compresses a dynamic range to a range in which the operator can observe or a degree of correction are prepared for each photographing region and stored in the memory section 33 as a processing condition table 331.

Also, in the memory section 33, the photographic data created by the various image creating apparatuses 2 is stored temporary. Meanwhile, in case the examination object information is appended to the photographic data, the photographic data and examination object information are associated to be stored in the memory section 33. Other than that, in the memory section 33, various kinds of information, such as the patient list formed in the reception order of the patients, having been transmitted to the control device 3 is stored.

The input section 34 is configured with an unillustrated keyboard having cursor keys, numeral input keys and various function keys and a pointing device such as a mouse, and represents a first input device to input the examination object information to identify the object of photographing i.e. the object of examination (patient).

Via the input section 34, the retrieval ID corresponding to the patient which is a retrieval key to extract a desired image data of the patient in the image data stored temporary in the memory section 33, and individual patient information corresponding to the image data extracted, for example, the name of the patient are inputted. The input section 34 is configured to output an instruction signal which is inputted into the CPU 31 by operating the keys of the keyboard or the mouse. Meanwhile, the patient information inputted via the input section 34 may include gender, date of birth, age and blood type.

The display section 35 configured with, for example, CRT (Cathode Ray Tube) or LCD (Liquid Crystal Display), is a display device to display the examination object information such as the photographic data, the defined photographic data created from the photographic data thereof, retrieval ID and the information of the patient as described later. The display section 35 displays various screens in accordance with an instruction of a display signal inputted from the CPU 31.

On the present embodiment, for example, when a patient is accepted via the reception device 11a, a patient list is made in accordance with the reception order and is transmitted via the network 6 to the control device 3. When the doctor inputs an instruction signal through the input section 34 to display the patient list, a patient list display screen 35a is displayed on the display section 35.

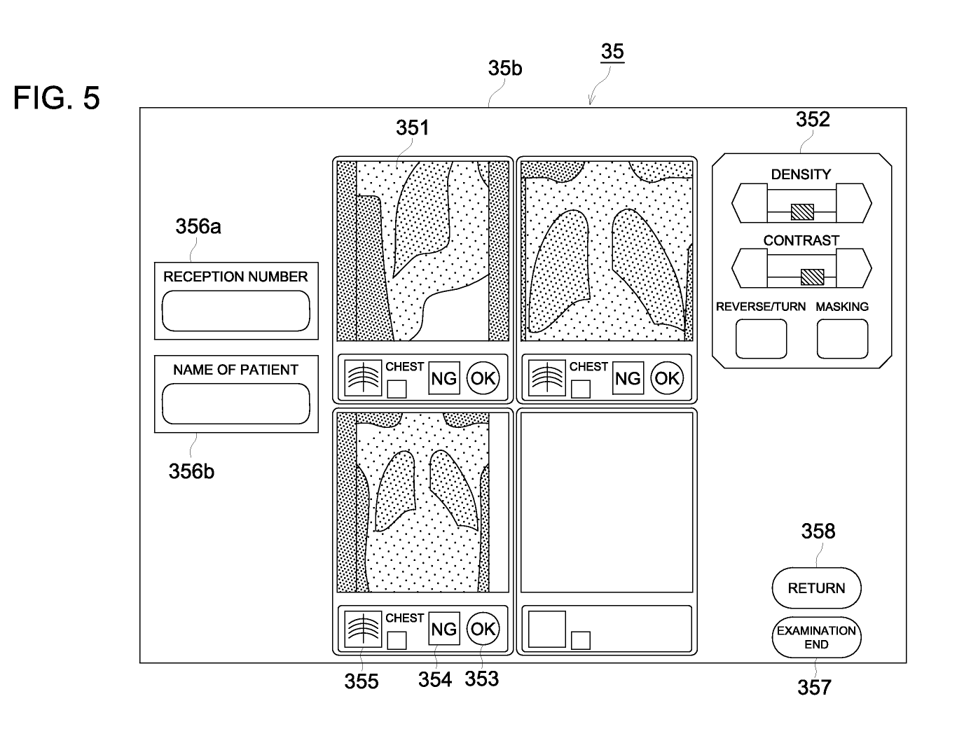

Also, for example, when the doctor inputs an instruction signal through the input section 34 to display photographic data obtained from the ultrasonograph 2a, the endoscope imager 2b or radiographic imager 2c representing the image creating apparatus 2, an image confirmation screen 35b shown in FIG. 5 is displayed.

As FIG. 5 shows, in the image confirmation screen 35b, an image display column 351 to display photographic data created by the various image creating apparatuses 2 and image processing condition adjusting column 352 to input an adjustment instruction of the image processing condition are provided. Also, in the image display column 351, an OK button 353 allocated to correspond with each display column of the image display column 351 so as to define the photographic image displayed at each display column and store the photographic image data thereof as a defined photographic image data, a NG button 354 to instruct deletion or repeat of outputting of the photographic image data displayed on each display column, and a photographed region display column to display a determined photographed region which is a result of determination through automatic region determination where the photographed region of the patient is determined for each photographic image. Meanwhile, in case the photographic data is stored as the defined photographic data, a mark to denote that data has been stored may be displayed at each display column of the image display column 351.

Also, on the image confirmation screen 35b, a examination object information input column 356 to input the serial number (reception number) described on the patient registration card held by the patient and the mane of the patient is provided. In the present invention, an example, where a reception number column 356a to input and display the reception number and a patient name column 356b to input and display the name of the patient are provided, will be explained as the examination object information input column 356 as follows without the examination object information input column 356 being limited to the example thereof.

Other that the above, in the image confirmation screen 35b, an examination termination button 357 to terminate examination, a return button 358 to return to a former screen are provided. Meanwhile, the configuration of the image confirmation screen 35b is not limited to the one exemplified in FIG. 5. For example, display columns and buttons other than the above can be provided and a column to display the reception number corresponding to the patient list can be provided.

The communication section 36 configured with a network interface performs data communication between external equipment connected via a network. The communication section 36 receives the photographic data created by the image creating apparatus 2 and functions as an output device to transmit and output the defined photographic data, in which image processing has been completed, to the external equipment such as a server where necessary.

The image processing section 38 executes a program for image processing stored in the memory section 33 and creates processed image data by applying various image processing for the photographic data. Also, image analysis is carried out for image processing. If radiography photographic is exemplified, as the image processing normalizing processing, tone conversion processing, frequency enhancement processing and dynamic range compression processing can be quoted. For the above processing, histogram processing is conducted.

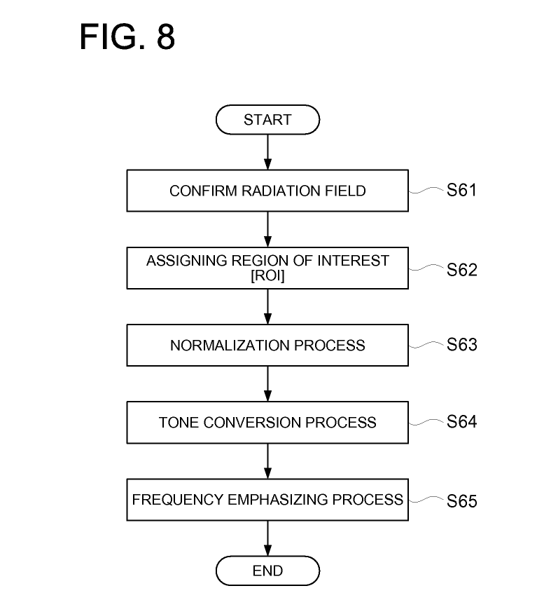

FIG. 8 is a flow chart explaining a flow of the image processing in the image processing section 38.

The image processing section 38 executes radiation field confirmation processing for photographic data as preliminary processing before tone conversion processing or frequency enhancement processing (Step S61). A radiation field means an area where the radiation ray reaches through the photographic object and in the radiation field confirmation processing, the radiation field area and outside area of radiation field are distinguished. This is because, if tone conversion processing is carried out for a biased signal value (digital signal value) including an image outside the radiation field, appropriate processing can not be executed.

Any method of radiation field confirmation can be utilized. For example, as Unexamined Japanese Patent Application Publication No. H5-7579 discloses, the radiation field area can be distinguished by dividing the photographic data into small areas, obtaining a dispersion value for each divided area, and detecting an edge of the radiation field area based on the dispersion value thereof. Usually, since a reached radiation amount is even in the radiation field area, the dispersion value of the small area is small. On the other hand, in a small area in which the edge of the radiation field area is included, since a portion where the amount of incoming radiation ray is large and a portion where the amount of incoming radiation ray is slightly reduced are mixed, the dispersion value becomes large. Therefore, the small area having the dispersion value larger than a certain value is deemed to include the edge, thus an area surrounded by such small area can be distinguished as the radiation field area.

When the radiation field area is distinguished, the image processing section 36 executes image analysis of the photographic image data to assign a region of interest (hereinafter called ROI) (Step S62). For example, in case of chest region image, the ROI is a chest field section. By preparing pattern images of the chest field section in advance, an image area which matches with the pattern image in the photographic image is extracted as the ROT. Then, a histogram of the image signal value in ROI is created.

As above, when the preprocessing is completed, the normalization processing is executed first (Step S63). Normalization processing is to compensate a fluctuation of radiation ray amount caused by variation of photographing conditions such as body type of the patient. The image processing section 38 assigns two signal values at specific proportions such as 10% from a high signal side and 10% from a low signal side in the above histogram as criteria level of the image data. For this proportion, an optimum proportion is obtained through statistics in advance by ROT. When the criteria level is determined, the criteria signal value is converted into a desired level.

After normalization processing, tone conversion processing is executed (Step S64). The tone conversion processing is processing to adjust tone of the radiography image in accordance with output characteristic of a monitor or a film. As mentioned above, a density characteristic of density and contrast of the output image can be adjusted. In the tone conversion processing, a tone conversion table is read out in accordance with the photographed region from a processing condition table 331 of the memory section 33, and tone conversion is executed using this table.

After the tone conversion processing, frequency enhancement processing is executed (Step S65). The frequency enhancement processing is processing to adjust sharpness of the image. In the frequency enhancement processing, for example, unsharp mask processing disclosed by Unexamined Japanese Patent Application Publication No. S62-62373 and multiple resolution analysis disclosed by Unexamined Japanese Patent Application Publication No. H9-44645 can be applied. In the un-sharp mask processing, a sharpness of a selected luminance portion can be controlled by executing a calculation shown by the following equation.

S=So+α(So−Sus) (1)

Hereat, S is a processed image, So is photographic image before processing, Sus is an un-sharp image obtained by equalizing the photographic image before processing and α is an enhancement coefficient.

Factors to control the sharpness are an enhancement coefficient α and a mask size of the un-sharp image which are set in accordance with the photographing regions and stored in the memory section 35 as image processing conditions. Thereby frequency enhancement processing can be carried out under the image processing conditions in accordance with the photographed regions in the same manner as tone conversion processing.

Dynamic range compression processing conducts correction to make an image to be in a density rage where visibility is enhanced through compression processing shown by an equation (2) by applying a method disclosed, for example, in U.S. Pat. No. 250,950.

S=So+β(A−Sus) (2)

Hereat, S is processed image, So is a photographic image before processing, Sus is an un-sharp image obtained by equalizing the photographic image before processing, β is a correction coefficient and A is a constant (threshold).

Factors to control degree of the correction are the correction coefficient β, and mask size of the un-sharp image which are set in accordance with the photographed regions and photographed conditions, and stored as the image processing conditions in the memory section 33. Thereby the frequency enhancement processing can be carried out under image processing conditions in accordance with the photographing regions in the same manner as the dynamic range compression processing.

The image processing conditions applied to the above processing is utilized in accordance with the photographing region of photographic image. The photographed region is judged based on the photographic image and photographed region information inputted by the CPU 31.

Next, various processing conducted by the CPU 31 will be described.

In the present embodiment, the CPU 31 conducts image processing appropriate for photographed regions on the photographic image data received though the communication section 36 and functions as an image processing device to create a defined photographic image data suitable for examination.

Specifically, the CPU 31 reads out a region identification parameter from the memory section 33 first, then conducts automatic region identification processing to identify a photographed region based on a contour or a shape appeared in the photographic image data created by the image creating apparatus 2. When the photographing region is identified, the CPU 31 creates defined photographic image data in conjunction with the image processing section 38. Namely as mentioned above, the image processing parameter corresponding to the photographed region is read out from the memory section 33, image processing conditions are determined based on the parameter read out and image processing such as tone processing to adjust contrast of the image, processing to adjust density and frequency enhancement, and processing to adjust sharpness, are applied to the image data under the conditions determined to create defined photographic image data for examination. Further, when the operator such as the doctor inputs an instruction to adjustment density or contrast of photographic image data from the image processing condition adjustment column 352, the CPU 31 conducts image processing on the photographic image data in response thereto. Then when the image processing is completed and the OK button 353 is pressed, the CPU 31 determines the photographic image data after image processing as the defined photographic image data.

Further, when the Retrieval ID which identifies the photographed object of examination is inputted as examination object information, the CPU 31 matches the defined photographic data after predetermined image processing and the patient via the Retrieval ID, and functions as a matching device to match patient information of the patient representing examination object information and defined photographic data.

Specifically, when the retrieval ID is inputted from the input section 34, photographic data appended to the same retrieval ID as the retrieval ID is retrieved and extracted among image data stored in the memory section 33 using the retrieval ID as a retrieval key. Then, the defined photographic data created form the extracted photographic data is matched with patient information (name of a patient) of a patient which is corresponded to the retrieval ID. Also, in case information to identify kinds of photographing as the examination object information is appended to photographic data, the information is also matched with the defined photographic data along with the patient information.

Next, operation of a small-scale diagnosis system 1 during examination of a doctor will be described.

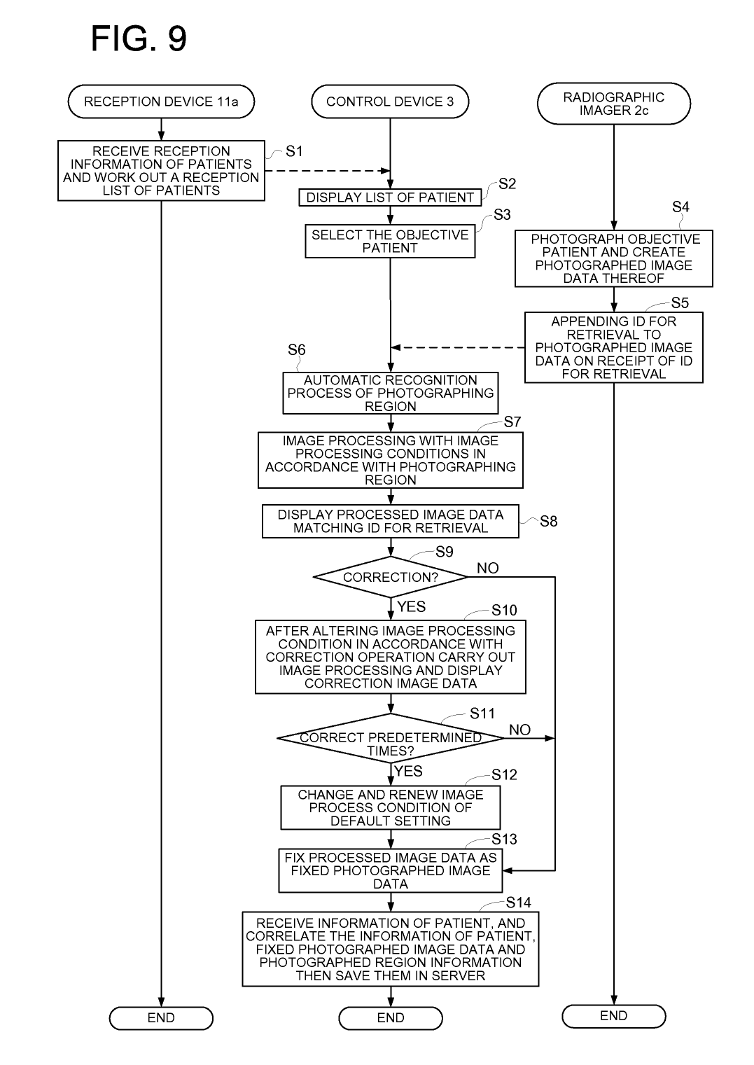

FIG. 9 is a flow chart to describe a flow of operation of the small-scale diagnosis system 1 during examination of the doctor. Operation flow of the small-scale diagnosis system 1 is described along with a workflow of the doctor with reference to FIG. 9 as follows.

When a patient arrives at the hospital, a reception number in reception order is given to the patient by a receptionist and a patient name is asked. Next, the receptionist operates a reception device 11a of an input section to input patient information such as the reception number and the patient name. At the reception device 11a, the reception information is received and, a patient list is created (Step S1). The patient list is transmitted to a control device 3 in an examination room 13 via a network 6.

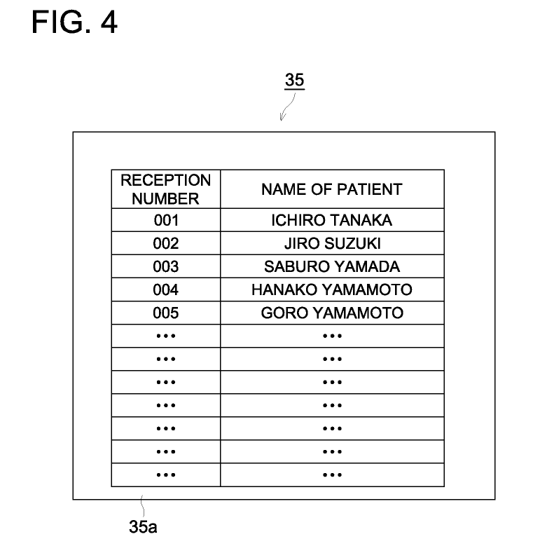

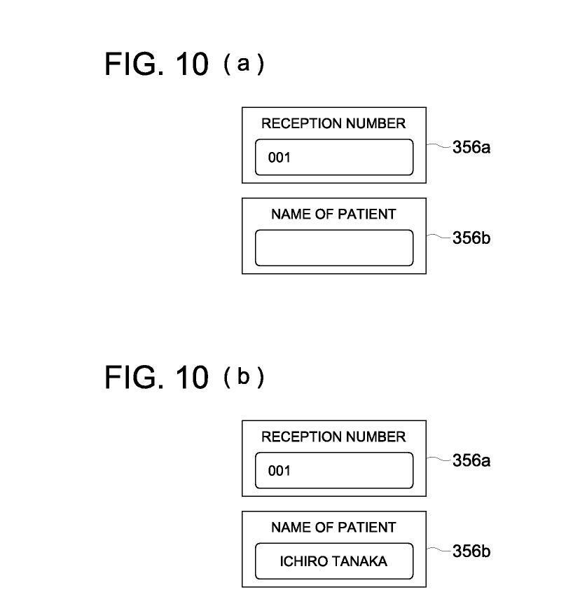

When the patient enter into the examination room 13, the doctor causes a display section 35 of the control device 3 to display a patient list display screen 35a (Step S2). On the patient list display screen 35a, as FIG. 4 shows, names and reception numbers of patient waiting for examination are displayed in the list. The doctor selects the patient of a photographic object (normally beginning at a top of the list) in the patient list (Step S3). At a stage where the patient is selected, as FIG. 10(a) shows, the reception number is displayed on a reception number column 356a and a patient name column 356b is displayed in a state of vacancy. The doctor asks the patient about his/her condition and determines photographing and examination to be conducted, thereafter the patient moves to a radiography room 15 where the image creating apparatus 2 is installed or a laboratory 16 as instructed appropriately. Meanwhile, in case examination is reserved in advance at that day, the patient may move from the reception 11 to the radiography room 15 or a laboratory 16 directly.

Also, the other patient can be selected after the patient is selected. In this case, the selected patients can be photographed simultaneously or successively using each image creating apparatus 2. Even in this case, as described later, since the retrieval ID is inputted as the examination object information when photographing by the image creating apparatus 2, by verifying the retrieval ID appended to the image data, the patients and the image data can be matched after photographing.

A case where radiography is conducted through the radiographic imager 2c will be described as follows. The same processing is carried out in the other photographing apparatuses 2a and 2b.

Before photographing, the doctor assigns and inputs readout conditions (sampling pitch) of the photographic image in the radiographic imager 2c through the control device 3. Based on the readout conditions, control information related to image forming is created by the CPU 31 in the control device 3 and transferred to the radiographic imager 2c.

Thereafter, in the radiography room 15, the doctor operates the radiographic imager 2c to adjust the photographing conditions and conducts photographing operation instruction. When photographing operation instruction is received, the photographing conditions are set in accordance with the photographing operation instruction in the radiographic imager 2c and then radiation is conducted by a photographic device 22 in accordance with photographing operation instruction and radiography is conducted. In accordance with the readout conditions related to image forming received from the control device 3, photographic image data is created by readout device 23 (Step S4).

Then, the retrieval ID i.e. the reception number is inputted by the doctor through the input operation section 21a of the image creating apparatus 2 and the photographic image data to which the retrieval ID is appended as a header information is transmitted to the control device 3 (Step S5). Meanwhile, in case information to specify kind of photography is inputted from the input operation section 21a as well, the information is appended to the photographic image data and transferred to the control device 3. Also, in case a plurality of times of photographing are carried out in different photographing directions, the above mentioned operation is repeated and the created photographic image data is successively transmitted to the control device 3.

In the control device 3, when the photographic data is received, the CPU 31 conducts automatic recognizing processing of the photographed region using the photographic image data (Step S6). Usually, in different photographed regions, a distribution of pixel values of the photographic image differs, therefore image processing to suite a status of the distribution has to be applied. Thus, to apply optimum image processing, the photographed regions in photographic are recognized.

As the automatic recognizing processing, for example, a method disclosed in Unexamined Japanese Patent Application Publication No. 2001-76141 can be applicable. In this method, first, main scanning and sub-scanning of the photographic image are carried out to extract an object area. In main scanning and sub-scanning, a differential value of each scanned pixel in respect to vicinity pixel is calculated. If the differential value is greater than a threshold, it is judged that the pixel is on a border point between object area and a blank area. Thus an area surrounded by the border points is extracted as the object area.

Next, an amount of characteristic is extracted for the object area. As the amount of characteristic, size of the object area (number of pixels), a shape of density histogram, a shape of centerline of the object area and a distribution of first differentiation values in main scanning and sub-scanning are quoted. A value of each amount of characteristic is normalized in accordance with a predetermined condition. For example, if the shape of a density histogram is similar to a shape pattern of chest, a normalization value is “1”.

Next, a correlation value between a vector of characteristic Pi(i=1, 2, . . . , n) where the extracted amount of characteristic is an element, and a vector of characteristic Si(i=1, 2, . . . , n) obtained for each photographed region of a standard body type in advance are obtained. A photographing region shown by a vector of characteristic Si having the highest correlation value is obtained as the photographing region of the photographic. Meanwhile, by comparing corresponding elements between the vector of characteristic Pi and the vector of characteristic Si, if the elements have the same value “1” is given to the correlation value and if elements have different values, “0” is given to the correlation value, thereby a total of correlation value of each element is obtained.

Meanwhile, other methods to recognize the photographed region such as a method disclosed in Unexamined Japanese Patent Application Publication No. H11-85950 can be applied without being restricted to the above method, and the methods are not limited thereto in particular.

As above, when the photographed region is automatically recognized, the photographic image data is outputted to the image processing section 38 along with information of the photographed region. In the image processing section 38, image processing conditions (tone processing condition and frequency enhancement processing condition) in a processing condition table 331 related to the recognized photographed region is identified and the image processing conditions thereof are read out. Then, various kinds of image processing are conducted for the photographic image data with the readout image processing conditions (Step S7).

For the radiograph image, as mentioned above, a plurality of kinds of processing such as normalizing processing and tone conversion processing are applied. In particular, in tone conversion processing, a tone conversion table corresponding to the photographed region is read out from the memory section 33, among tone conversion tables assigned as basic processing condition, and tone conversion of the radiographic image is carried out using the tone conversion table. Thereby, adjustment of density and contrast suitable for the photographed region is carried out.

The processed image data created by image processing is stored temporary along with the examination object information such as the retrieval ID appended to the image data in the memory section 33.

When the doctor inputs the reception number of the patient as retrieval ID, a processed image data corresponding to the patient is extracted from the memory section 33 using the reception number as a retrieval key. Then, as FIG. 5 shows, the extracted processed image data is displayed in the image confirmation screen 35b in a list (Step S8).

The doctor confirms the number and contrast of processed images and on the image confirmation screen 35b and presses an OK button 353 if correction is not necessary (Step S9: No) so as to define the processed image data as a defined photographic image data for examination (Step S13).

After defining the photographic image, the doctor correlates the defined photographic data to the examination object information such as the patient information of the patient while writing diagnostic findings in a medical chart. Specifically, as FIG. 10(b) shows, the name of the patient corresponding to the reception number is inputted through the input section 34, and the input information (patient information) inputted, the defined photographic data and the photographed region information are correlated (the input information is related as appended information) and stored in a storing device such as a database 5 of a server 4. When this occurs, if information such as the kind of photographing is appended to the photographic image data, these items of the information are stored with the defined photographic image data in the storing device such as database 5. Meanwhile, other than the name of the patient, detailed information of the patient such as address, gender and date of birth may be correlated.

The defined photographic image data correlated to the patient information and the photographed region information can be retrieved by the patient information and the photographed region information as the retrieving key. For example, the control device 3 is configured to be able to retrieve an image, and if a doctor wishes interpretation of radiogram of an image previously photographed in case the same patient visits at a later date, or a case is similar to that of other patient, the patient information or the photographed region information of the patient whom the doctor wish to retrieve are inputted though the control device 3. The control device 3 requests the server 4 the defined photographic image data corresponding to the patient information or photographed region information of the patient inputted. In the server 4, retrieval of defined photographic image data is carried out based on the patient information or the photographed region information and the defined photographic image data having been retrieved is transmitted to the control device 3 and displayed on the display section 33 as a reference image data in the control device 3.

On the other hand, if the doctor found necessity of correction after confirming the processed image data on the image confirmation screen 35b, (Step S9: Yes), a photography processing condition adjusting column 352 to change image processing conditions such as the density or the contrast is operated so that instruction operation is conducted to correct the image processing conditions. The CPU 31 modifies the tone conversion table 38 which has been read out as the image processing condition in accordance with changing rate specified by the photography processing condition adjusting column 352. Specifically, a characteristic curve related to tone conversion is modified. In the image processing section 38, tone conversion processing of the radiography image using the modified tone conversion table is carried out again, and corrected image data where the density and the contrast have been corrected is created. In the image confirmation screen 35b of the display section 35, the corrected image data is newly displayed in exchange for the processed image data (Step S10).

Next, by the CPU 31, the number of correction operation of the image processing conditions of the density and the contrast is incremented by 1 and counted to be recorded in the memory section 33. Then, the recorded count value is referred to judged whether or not the count reaches to a predetermined number in other words, whether or not the image processing conditions of the density and the contrast have been corrected a predetermined times is judged (Step S11).

If the correction has been carried out the predetermined times (Step S11; Yes), the image processing conditions is modified in accordance with a modification amount which has been modified at the predetermined times of correction and stored in the processing condition table 331 so as to renew the table (Step S12). For example, given that the predetermined times is ten times, an average value of modification amount when the tone conversion table is modified by ten corrections is obtained, and the tone conversion table recorded in the processing condition table 331 is modified using only the average value as the image processing condition, or the processing condition table 331 is modified by 60% of the average value so as to reflect operation of the doctor to image processing condition. After renewal, the flow proceeds to Step S13. Meanwhile, in Step S9, in case the processed image data displayed in the image confirmation screen 35b is unclear, which cannot be adjusted by adjusting the density and the contrast, a NG button 354 is operated to instruct destruction of the processed image data and repeat of output so as to destroy the processed image data and output the image data from the image creating apparatus 2 again.

As above, according to the small-scale diagnosis system 1 related to the present embodiment, the control device 3 causes display section 35 to display the photographic image data created by the image creating apparatus 2 so as to be observable, and creates defined photographic image data by adjusting the density and the contrast of the photographic image data, and then correlates the defined photographic data with the examination object information. These functions conventionally shared by workstations for consoles and workstations for viewers which are provided in separate positions in accordance with division of roles become available at one control device (workstation) 3, in view of a workflow in small-scale facilities such as medical practices or clinics. Thereby, since the doctor does not have to come and go between workstations and to carry out each operation, the doctor is relieved of workload and can concentrate on examination. As a result an accuracy and efficiency of examination are enhanced. Also the system can be configured readily and a space for installing the system can be reduced.

Also, since the defined photographic image data is stored in the database 5 of the server 4 along with the patient information about the patient after the defined photographic image data is associated to each patient via the retrieval ID, the image data can be used as a comparison image to judged progress of healing at later inspection.

Further, since examination is carried out while the photographic data is being displayed on the display section 35, films are not necessary to be used for examination and for storing image data, therefore cost saving can be realized.

Also, since the photographing order information such as the photographing region is not inputted and created before photographing and examination, time and labor such as input operation through the keyboard is reduced and workload of the doctor can be relieved. Thereby, in the small-scale medical facilities, since the number of apparatuses and doctors is small, and a moving distance of the patient in the facility is short, the photographic image data and the patient cannot be mismatched without inputting photographing order information in advance, therefore, effective system operation suitable for a usage environment is possible.

Also, since a plurality of kinds of image creating apparatuses 2 such as the ultrasonograph 2a, the endoscope imager 2b and the radiographic imager are provided, minimum required photographing and examination can be conducted. Also, since photographing can be carried out simultaneously and concurrently for a plurality of patients, the efficiency of examination can be enhanced.

Further, to the ultrasonograph 2a representing image creating apparatus 2, a conversion device 21 is connected, thus even in case the ultrasonograph 2a outputs image data which does not conform to specification of existing apparatuses which have been provided in each facility to which the small-scale diagnosis system is applied, image data can be conformed by appropriately converting. Therefore, the existing apparatuses can be used as they are and cost of facility investment is not necessary.

Also, since the examination object information can be appended to the photographic image data though the conversion device 21, correlation between the image data and the patient representing a photographic object, and correlation between the information such as kind of photography and the image data are possible at a time point of photographing. Thus a risk of mismatching at later examination can be prevented, and time and labor to input kinds of photography afterward can be saved.

Also, after selecting a patient, extracting an image via corresponding retrieval ID, and inputting individual patient information through the input section 34, other patient can be further selected, therefore a plurality of patients can be photographed sequentially or simultaneously and concurrently using each image creating apparatus 2. Thereby the efficiency of examination can be enhanced.

Also, in the control device 3, recognition processing of the photographed region is automatically carried out for the photographic image data, and the image processing suitable for the recognized photographed region is carried out, thus it is possible to obtain the processed image data to which optimum image processing to suite the photographed region has been applied. Therefore, waiting time of the patients can be shorten.

Also, for the processed image data which has been automatically processed by image processing, the image processing conditions of the data thereof can be corrected. Thus, image quality correction can be conducted in accordance with doctor's preference of interpretation of radiogram.

Further, in case the image processing condition is corrected predetermined times, the correction is reflected to a default image processing condition thus an optimization of the image processing in accordance with the doctor is possible through operation.

Meanwhile, the configuration to correlate the patient with the photographic image data is not restricted to the one shown by the present embodiment. For example, first, photographing is carried out without carrying out selection of a patient or so forth, then after photographing, the retrieval ID can be inputted as the examination object information while the doctor is examining the patient observing the photographic image data on the display section 35 of the control device 3. In this case, the retrieval ID is inputted at the image creating apparatus 2 at a time of photographing, and after photographing, the image data obtained by photographing is opened from an undefined folder in the control device 3 to input the retrieval ID from the input section 34. Thereby, the photographic image data and the patient are correlated via retrieval ID and the patient information about the patient is correlated to the photographic image data. In an usage environment where examination and photographing are conducted between the doctor and the patient person-to-person, even in the above system configuration, there is not a risk of mismatching of the patient and the photographic image data, and the doctor can be relieved of workload by minimizing the input operation. Also, in case of such system, since a patient list is not necessary to be made, a system configuration having no reception device 11a is possible.

Also, when the patient is selected from the patient list on the display section 35 of the control device 3, a display screen of the display section 35 can be automatically replaced with the image confirmation screen 35b, then after photographing, the photographic image data of the photographed patient can be displayed on the image confirmation screen 35b. In this case, since the patient selected from the patient list and patient who has been photographed are associated one-to-one, there is no risk that the patient and the photographic image data are mismatched though the retrieval ID is not inputted before photographing. Therefore, input operation is minimized and the doctor is relieved of the workload.

Also, in the present embodiment, while the input section 34 of the control device 3 functions as an input device to input the examination object information, the input device is not restricted thereto. For example, a configuration where each image creating apparatus 2 and the conversion device 2 are provided with the input devices to input the examination object information is possible.

Also, in the present embodiment, the examination object information about the patient who has been photographed and examined is transmitted to the reception device 11a having a function of Rececom™, however in case an electronic chart is introduced, there can be a configuration that the examination object information is transmitted to the electronic chart, information lacking in the electronic chart is inputted and the information is transmitted from the electronic chart to the reception device 11a having the Rececom™ function.

Also, in the present embodiment, the defined photographic image data and the patient information corresponding thereto, are stored in the server 4, however the storing device to store the defined photographic image data and the patient information corresponding thereto is not restricted thereto. For example, a configuration where the memory section 33 of the control device 3 is a storing device to store the defined photographic image data and the patient information corresponding thereto is possible.

### Second Embodiment

Next, a second embodiment of the small-scale diagnosis system related to the present invention will be described. In the first embodiment described above, to recognize the photographed region of the photographic image, by analyzing the photographic image data from scratch, the photographed region is automatically recognized, however in the present embodiment, using a human body region icon displayed on the display section, the doctor select a broad photographing region, and the photographed region is automatically recognized based on information of the broad region.

Meanwhile, the small-scale diagnosis system 1 in the present embodiment has the same configuration as the first embodiment described above, and the portions having been described are denoted by the same symbol to omit the description.

In the following description, as the radiographic imager 2c of the image creating apparatus 2, a CR device using a portable cassette in which a photostimulable phosphor plate is stored is exemplified for description. The radiographic imager 2c of the present embodiment uses a photostimulable phosphor substance to carry out radiography of an object, and radiation energy having passed through the object is accumulated in the photostimulable phosphor substance, then by reading out an image accumulated in the photostimulable phosphor substance, a photographic image data is created. In this type of radiographic imager 2c, a readout device 23 is provided with an radiation source and the photostimulable phosphor substance is incorporated. There are two types i.e. a type in which from photographing to readout is carried out in one unit and the other type using a portable cassette in which the photostimulable phosphor plate is stored. As described above, in the present embodiment, the CR device of cassette type will be exemplified for description, without the present embodiment being restricted thereto.

The radiographic imager 2c is configured with a photographing device 22 having a radiation source and a readout device 23 to create the photographic image data by reading out an image form the photostimulable phosphor plate stored in the cassette having been used for radiography in the photographing device 22 (Refer to FIG. 2).

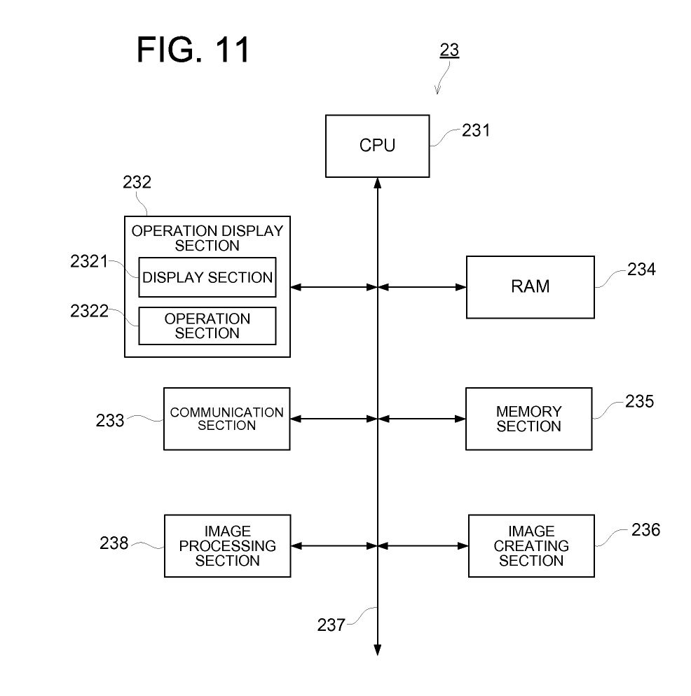

FIG. 11 is a block diagram of relevant sections showing a schematic configuration of the readout device 23. As FIG. 11 shows, the readout device 23 is provided with a CPU 231, an operation display section 232, a communication section 233, a RAM 234, a memory section 235, an image forming section 236 and an image processing section 238 and each section is connected via a bus 237.

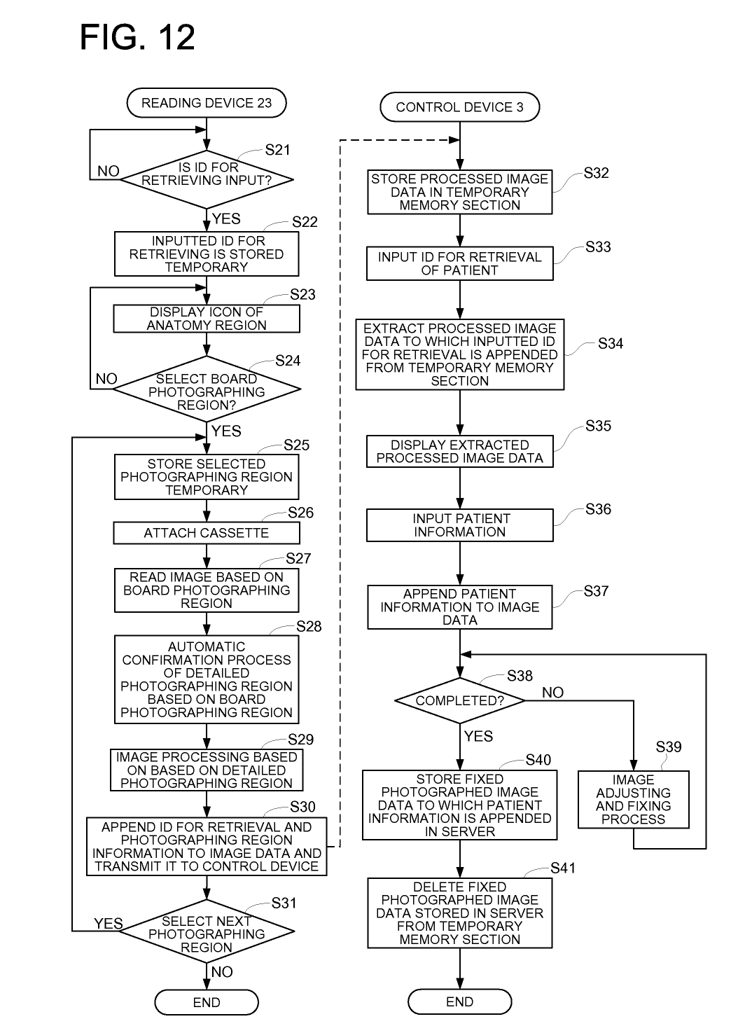

The CPU 231 reads out a control program stored in the memory section 235, downloads in a work area formed in the RAM 234 and controls each section of the readout device 23. Also, the CPU 231 reads out various processing programs stored in the memory section 235 in accordance with the control program 235 and downloads in the work area. In conjunction with the program having been read out, the CPU 231 conducts various kinds of processing such as processing carried out by the readout device 23 side shown by FIG. 12. For example, region recognition processing to automatically recognize the photographed region through image analysis and image processing such as tone conversion processing and frequency enhancement processing are executed.

The operation display section 232 is configured with a display section 2321 and an operation section 2322. The display section 2321 is configured with a display screen made up of a CRT (Cathode Ray Tube) or a LCD (Liquid Crystal Display), and displays the patient list and the human body region icon described later on the display screen in accordance with a display signal inputted form the CPU 231.

The operation section 2322 is configured with a ten keyboard. A pressing signal of the key caused by ten key pressing operation is outputted to the CPU 231 as an input signal. Also, the operation section 2322 is provide with a touch panel disposed to cover an upper surface of the display section 2321 so as to detect an input position which is pressed and inputted by operation using fingers of a user and to transmit the detected signal to the CPU 231.

The communication section 233 configured with a network interface conducts data communication with external equipment connected via the network 6 (Refer FIG. 1).

RAM 234 forms a work area to temporary store various programs executable by the CPU 231, input and output data, and parameters read out form the memory section for various kinds of processing executed by the CPU 231.

The memory section 235 is configured with a nonvolatile semiconductor memory to store various kinds of data such as a control program, various programs and a patient list. Also, the memory section 235 stores an human body region icon in shape of an a human body where each region (head region, neck region, chest region, abdominal region) roughly dividing the human body can be selected. Also, as FIG. 6 shows, a processing condition table 331 (lookup table where a tone curve used in tone processing is defined and enhancement degree of frequency enhancement processing) to carry out image processing suitable for the recognized photographed region described in the first embodiment is stored.

The image forming section 236 is a readout device configured to be able to attach a cassette having been used for radiography. The image forming section 236 brings out the photostimulable phosphor plate from the cassette attached so as to scan by an excited light, causes radiography image information accumulated and stored in the photostimulable phosphor plate then illuminated photostimulably to create an image data based on the image signal obtained by reading the photostimulable illumination light photoelectrically.

The image processing section 238 executes a program for image processing stored in the memory section 235 in conjunction with the CPU 231 to create processing image data by applying various kinds of image processing on the photographic image data. Also, the image processing section 238 executes image analysis for image processing. Hereat a radiographic image is exemplified. Normalization processing, tone conversion processing, frequency enhancement, and dynamic range compression processing are quoted as the image processing. Histogram analysis is carried out for the above processing. Meanwhile, the image processing section 238 has the same function as that of the image processing section 38 of the control device 3 in the first embodiment.

Next, in a small-scale facility where the small-scale system 1 is applied, a processing flow of a patient from visiting the hospital to leaving the hospital will be described with reference to FIG. 2, FIG. 11 and FIG. 12.

When the patient visit the hospital, at the reception 11 shown in FIG. 2, a receptionist of the reception operates the input section of the reception device 11a to input patient information such the reception number and the patient name. In the reception device 11a, the patient list is created when receiving an input of the reception information from the input section. The patient list is transmitted to the control device 3 of the examination room 13 via network 6.

The patient to whom the reception number is appended waits at the waiting room 12, and moves to the examination room 13. In the examination room 13, the doctor asks the patient about patient's condition. Then details of photographing (kid of the image creating apparatus 2, photographing region, photographing direction and number of photographs) and laboratory test (blood test, urine and feces examination, sampling of piece of tissue) are determined.

If photographing of an affected area is determined to be necessary by the interview, a photographer such as the doctor or the photographic technician to conduct photographing, brings the patient in front of the image creating apparatus 2 (the ultrasonograph 2a, the endoscope imager 2b or the radiographic imager 2c), then inputs the reception number (retrieval ID) through the input operation section (in case of the, radiographic imager 2C, ten key of the control section 2322) and photographs the examination object region of the patient as the photographic object to create photographic image data.

FIG. 12 is a flow chart showing operation of the small-scale diagnosis system in the second embodiment. The flow chart shows creation processing of the photographic image data of the patient conducted in the control device 3 and readout device 23 and details of a flow of correlation processing where the photographic image data and the patient are correlated, in case photographing in the radiographic imager 2c is determined to be necessary according to the interview of the doctor, With reference to the FIG. 12, the flow of creation processing of the photographic image data of the patient conducted in the readout device 23 and correlation processing of the photographic image data and the patient in the control device 3 will be described along with a workflow of facility staff (doctor, photographic technician and receptionist) as follows.

First, the photographic technician inputs the retrieval ID through the ten key of the operation section 2322 provided at the readout device 23.

At the readout device 23, when the ten key of the operation section 2322 is pressed and the retrieval ID is inputted (Step S21), the retrieval ID having been inputted is temporary stored in the RAM 234 (Step S22), and the human body region icon to accept selection of the region to be a photographic object i.e. the photographing region is displayed on the display section 2321 (Step S23).

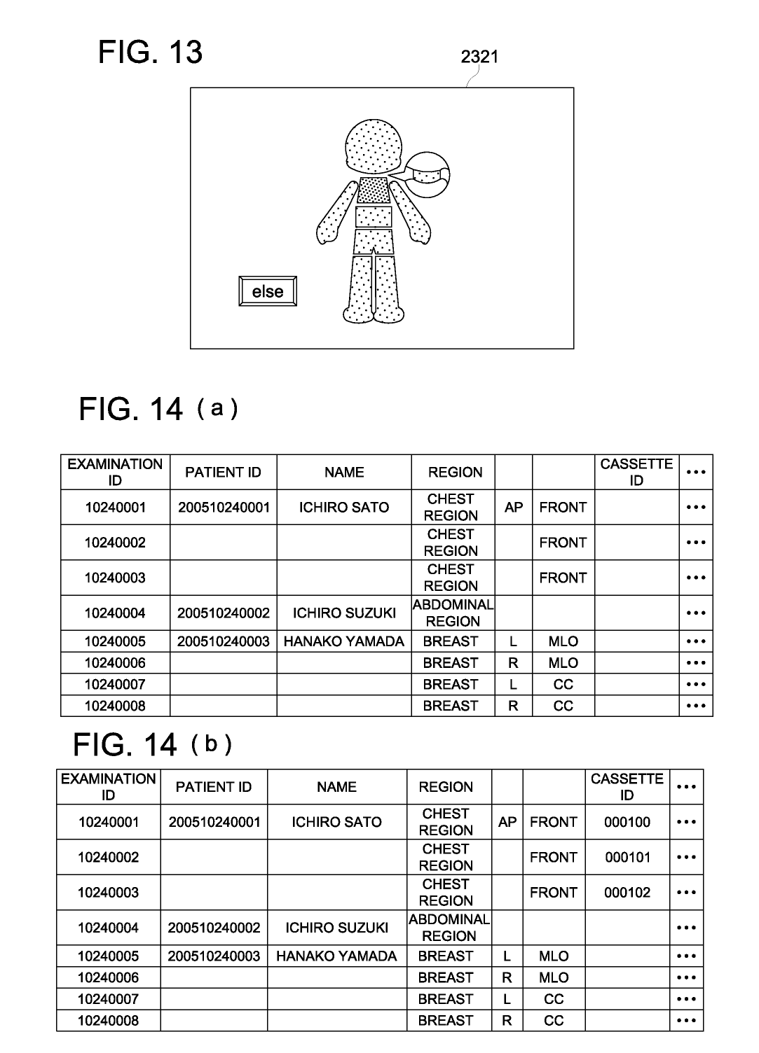

In FIG. 13, a display example of the human body region icon in the display section 2321 is shown. The human body region icon is an human body shape icon where each region (for example, head region, neck region, chest region, abdominal region, pelvic and four limbs) roughly dividing the human body can be selected. When any one of the region in the human body region icon is pressed, the touch panel of the operation section 2322 inputs the pressed position to the CPU 231. Meanwhile, a configuration that the human body icon is only for display, and the each region of the human body icon blinks sequentially in accordance with pressing times of a predetermined key (in FIG. 3 “else” key) (for example, head region plinks by single pressing, neck region blinks by double pressing, . . . ) and then the blinking region while the cassette is attached is selected as a broad photographing region is possible. According to the above configuration, even in case pressing of each region in the human body region icon cannot be recognized correctly in a touch panel since the touch panel is small, the photographed region can be correctly selected.

The photographic technician selects the region of photographic object among the human body region icon when the human body region icon is displayed on the display section 2321. In the photographing device 22, the cassette is set and radiography is conducted for the patient and then the cassette having been photographed is loaded to the reading device 23.

In the readout device 23, when a broad photographing region is selected form the human body region icon (Step S24; Yes), information of the selected broad photographing region is stored temporary in the RAM 24 (Step S25). Then, the cassette waits to be loaded. When the cassette is loaded (Step S26), in the image forming section 236, readout of the radiographic image information recorded in the photostimulable phosphor plate in cooperated in the cassette is carried out base on the broad photographed region selected in the Step S24 and photographic image data is created (Step S27). Specifically, the photostimulable phosphor plate is brought out from the cassette loaded to the image forming section 236 and scanned by the exited light and the radiography image information recorded in the photostimulable phosphor plate photostimulabley emits light. The photostimulabley emitted light is read photoelectrically so as to obtain an image signal and the image signal is processed by A/D conversion with a predetermined sampling pitch, thereby photographic image data is created.

When the photographic data is created, automatic recognition of the photographed region is carried out based on the broad photographed region selected in Step S24 (Step S28). Thus, from the broad regions selected in the human body shape icon such as the head region, neck region, chest region, abdominal region pelvic and four limbs, further detailed photographed regions (the head region for a chin, mouth and nose, and chest region for a lung field, and breastbone are recognized. Specifically, automatic recognition can be carried out in the same method as that in the above first embodiment such as methods disclosed in Unexamined Japanese Patent Application Publication Nos. 2001-76141 and H11-85950.

When the detailed photographed region is recognize, the photographic image data is outputted to the image processing section 238 along with the information of the photographed region. In the image processing section 238, the image processing conditions (tone processing condition and frequency enhancement condition) of a processing table 311 corresponding to the recognized photographed region are specified and read out. Then with the image processing condition read out, various kind of image processing is carried out for the photographic image data based on the recognized photographed region (Step S29).

When the image processing is completed, in the readout device 202, the retrieval ID inputted in Step S21 and the information of the photographed region selected in Step S24 are written onto a header section of the photographic image data (processed image data) having been processed by image processing as supplementary information, and transmitted to the control device 3 via the communication section 233 (Step S30). When selection of a subsequent photographing region from the human body region icon displayed on the display section 2321 is detected (Step S31; Yes), operation returns to Step S25, and processing in Steps S26 to S30 is repeated and executed.

In the control device 3, when the processing image data (including the supplementary information) is received from the image creating apparatus 2, the received processed image data is stored in the memory section 33 (Step S32).

When photographing is completed, the patient moves to the examination room. The doctor operates the input section 34 of the control device 3, to display an unillustrated image retrieval screen on the display section 35 and inputs the reception number (the retrieval ID) of the patient. In the control device 3, when a display instruction of an image retrieval screen is inputted from the input section 34, the image retrieval screen to receive an input of the retrieval ID is displayed on the display section 35, and when the retrieval ID is inputted from the screen thereof via the input section 34 (Step S33), the processed image data in which the inputted retrieval ID is included in the supplementary information is extracted from the memory section 33 (Step S34) and then a thumbnail image which is a reduction of the extracted processed image data is formed and displayed in the image confirmation screen 35b (Refer to FIG. 5) of the display section 35 (Step S35).

When the patient information of the patient who is the object of examination from the patient information input column 231f via the input section 34, the retrieval ID of the supplementary information of the processed image data extracted in Step S34 is clobbered on the patient information having been inputted and the patient information is associated to the processed image data (Step S37). Until termination of examination is instructed by pressing a end button of the image confirmation screen 35b (Step S38; No), image adjusting processing or image definition processing is executed in accordance with instructions of image processing adjustment or definition of the image form the image confirmation screen 35b (Step S39). When termination of examination is instructed by pressing the end button of the image confirmation screen 35b (Step S38; Yes), the defined photographic image data to which the patient information is appended is transmitted to the server 4 via the communication section 36, and stored in the database 5 (Step S40). Then the defined photographic image data written in the database 5 of the server 4 is deleted from the memory section 33 and the processing is terminated (Step S41).

Meanwhile, in case photographing in the image creating apparatus 2 except by the radiographic imager 2c is determined, the retrieval ID is inputted from the input operation section of the image creating apparatus 2 having been determined. After photographing, the inputted retrieval ID is written onto the header section of the photographic image data, and transmitted to the control device 3. The process flow in the control device 3 is the same as that in steps S 11 to 20 in FIG. 5.

When examination of the patient in the examination room is completed, the patient moves to the reception 11 and settles account. The doctor records an observation (examined injury or disease) of the patient, information of medicine used to indicate the medicine having been prescribed for the patient and information of photographing of the patient (kind of apparatus used for the photographing, number of the photographs, usage of contrast agent, photographed region and photographing direction) on a paper chart, then passes the paper chart to the receptionist of the reception 11.

The receptionist causes the reception device 11a to display a receipt related information input screen (unillustrated) and input, the reception number of the object patient and receipt related information not having been registered yet based on the description of the paper chart from the receipt related information input screen. At the reception device 11a, based on the inputted receipt related information, accounting information processing and health insurance point calculation processing are carried out. The receptionist charges the patient examination fee based on calculated accounting information to carry out accounting.

As described above, by the readout device 23, when the ten key of the operation section 2322 is pressed and the retrieval ID is inputted, the human body region icon is displayed. When a broad photographing region is selected from the displayed human body region icon and the cassette is loaded, the image creating section 236 reads radiographic image information recorded on the photostimulable phosphor plate incorporated in the cassette and the photographic image data is created with a sampling pitch determined in accordance with the broad photographing region in advance. Then, by analyzing the created photographic image data, a detailed photographed region is automatically recognized and the image processing such as ROI extracting processing and tone processing is applied according to the detailed photographed region. The information of the photographed region is written onto a header of the processing image data having been processed by image processing and the processing image data is transmitted to the control device 3 through the communication section 233.

Therefore, in the small-scale facility, before automatically recognizing the photographing region by analyzing the photographic image data, the broad photographed region is selected from the human body region icon displayed on the display section 235 through a simple operation and the photographed region is automatically recognized based on the broad photographed region. Thereby, region recognition processing to recognize the detailed photographed region does not have to be carried out from scratch thus efficiencies of processing and examination can be enhanced. Also, when the detailed photographed region is automatically recognized, since the photographed region is narrowed down to a specific area by selecting the broad photographed region, recognition error by automatic recognition is reduced and recognition accuracy is enhanced.

Meanwhile, the description in the above embodiment is a preferable example of the small-scale diagnosis system 1 related to the present invention without the present invention being limited thereto.

For example, in the above embodiment, image processing is applied to the photographic image data in the readout device 23, however it can be carried out in the control device 3. In this case, since the photographed region is also written as the supplementary information of the photographic image data, region recognition processing to recognize the photographed region does not have to be carried out from scratch in the control device 3, and the processing programs and the parameters corresponding to the photographic region can be read out rapidly to carry out image processing, thus the processing efficiency can be enhanced.

Also, when the retrieval ID is inputted in the readout device 23, the retrieval ID is transmitted to the control device 3, and when the photographed region is selected, the photographed region information is transmitted to the control device 3. When the control device 3 side receives the photographic image data from the image creating apparatus 2, the retrieval ID transmitted from the readout device 23 most recently and the photographed region are associated to the photographic image data having been received. Namely, the retrieval ID thereof and the photographed region thereof can be written as the supplementary information of the photographic image data. With the above configuration, even in case photographing except by the radiographic imager 2c, by carrying out photographing, selecting the retrieval ID of the patient and the photographed region from the readout device 23 before photographing, the technician can confirm the photographed region in the photographic image data having been photographed in the control device 3. Therefore, in case the image processing is conducted by the control device 3, the region recognition processing does not have to be carried out from scratch and the processing programs and the parameters corresponding to the photographed region can be read out rapidly to carry out image processing, thus the processing efficiency can be enhanced.

It is needless to say that the present invention is not limited to the above embodiments and can be appropriately modified.

1-17. (canceled)

18. A small-scale diagnosis system to photograph a patient representing an examination object and create image data, thereafter display and provide the image data on a viewer for examination, correlate the image data displayed on the viewer with the patient, and store the correlated image data and information about the patient, the small-scale diagnosis system, comprising:
an image creating apparatus for creating photographic data of the examination object based on the image data obtained by photographing the patient;
an image processing device for creating defined photographic image data from the photographic image data created by the image creating apparatus;
a first input device for inputting examination object information to identify the examination object;
a correlation device for associating the defined photographic image data created by the image processing device and the examination object information corresponding to the defined photographic image data;
a storing device for storing defined photographic image data having been associated by the correlation device and the examination object information; and
a display device capable of displaying at least one of the photographic image data, the defined photographic image data and the examination object information;
wherein a control device is provided with at least the image processing device, the correlation device and the display device.

19. The small-scale diagnosis system of claim 18, wherein a quantity of the image creating apparatuses is plural and a quantity of the control device is one.

20. The small-scale diagnosis system of claim 19, wherein a plurality of the image creating apparatuses are configured with a plurality of kinds.

21. The small-scale diagnosis system of claim 18, wherein the image processing device has a function for correcting at least one of density and contrast of the photographic image data.

22. The small-scale diagnosis system of claim 18, wherein the image creating device comprises an information appending device for appending the examination object information to the photographic image data created.

23. The small-scale diagnosis system of claim 18, wherein the image creating device comprises a conversion device for converting an analogue signal to a digital signal.

24. The small-scale diagnosis system of claim 23, wherein the information appending device is the conversion device.

25. The small-scale diagnosis system of claim 18, further comprising a recognition device for conducting image analyzing of the photographic image data created by the image creating apparatus and for recognizing a photographed region in the photographic image data based on a result of the analysis; wherein the image processing device carries out image processing for the photographic image data created by the image creation apparatus based on a predetermined image processing condition in accordance with the photographed region recognized by the recognition device, and the display device displays the processed image data on which the image processing has been carried out by the image processing device for examination.

26. The small-scale diagnosis system of claim 25, further comprising a second input device for inputting correction information of the image processing condition in the image processing device, wherein the image processing device carries out image processing on the photographic image data with the image processing condition which has been modified based on the correction information inputted through the second input device, and the display device renews the processed image data with corrected image data on which image processing has been carried out with modified image processing condition and displays the corrected image data.

27. The small-scale diagnosis system of claim 26, wherein the storing device correlates the examination object information inputted through the first input device with the processed image data or the corrected image data and stores the information thereof.

28. The small-scale diagnosis system of claim 26, further comprising a condition renewal device for renewing the image processing condition predetermined in accordance with the photographed region.

29. The small-scale diagnosis system of claim 26, wherein the image processing condition to which correction information can be inputted includes density and contrast.

30. The small-scale diagnosis system of claim 18, wherein the image creating apparatus is a radiography apparatus or a FPD.

31. The small-scale diagnosis system of claim 18, wherein the image creating apparatus is an radiography apparatus comprising a photography apparatus to carry out radiography of the patient using a cassette in which a photostimulable phosphor plate is incorporated, and a readout apparatus to read out radiographic image information of the patient recorded on the photostimulable phosphor plate incorporated in the cassette for creating the photographic image data, and the readout apparatus comprises a display device to display a human body region icon to indicate each region of a human body on a display screen, a selecting device for selecting and inputting a region corresponding to a photographing region of the patient from the human body region icon indicating each region of the human body, a readout device for obtaining the photographic image data by reading the radiographic image information of the patient recorded on the photostimulable phosphor plate incorporated in the cassette.

32. The small-scale diagnosis system of claim 31, wherein the information appending device appends information of the region selected by the selecting device to the photographic image data.

33. The small-scale diagnosis system of claim 31, wherein the recognition device carries out image analyses on the photographic data based on the region selected by the selecting device and recognizes a detailed photographed region in the photographic image data based on a result of the analysis.

34. The small-scale diagnosis system of claim 31, wherein a touch panel is laminated on the display screen of the display device, and the selecting device is configured with the human body region icon displayed on the display device and the touch panel.
